(19) United States
(12) Patent Application Publication
(10) Pub. No.: US 2010/0155665 A1
(43) Pub. Date: Jun. 24, 2010

(54) Nano phosphor, method of preparing the same, and display including the nano phosphor

(75) Inventors: Hyun-sik Kim, Yongin-si (KR); Soon-jae Kwon, Yongin-si (KR); Soo-yeon Seo, Yongin-si (KR); Gyeong-su Park, Yongin-si (KR)

Correspondence Address: ROBERT E. BUSHNELL & LAW FIRM, 2029 K STREET NW, SUITE 600, WASHINGTON, DC, 20006-1004, US

(73) Assignee: Samsung SDI Co., Ltd., Suwon-si (KR)

(21) Appl. No.: 12/654,363

(22) Filed: Dec. 17, 2009

(30) Foreign Application Priority Data
Dec. 19, 2008 (KR) 10-2008-0130380

(51) Int. Cl. C09K 11/61; C09K 11/08; C09K 11/63

(52) U.S. Cl. 252/301.4 H; 252/301.4 R; 977/773

(57) ABSTRACT

A nano phosphor prepared by mixing a metal oxide nanoparticle and inorganic salt, a method of preparing the nano phosphor, and a display device including the nano phosphor. The method includes dissolving the inorganic salt in a solvent, adding the metal oxide nanoparticles to the solution, and annealing the resultant mixture, preferably under pressure. Such a process removes defects in the crystal structure of the nano phosphor, resulting in improved luminescent efficiency when incorporated into a display device.

### CLAIM PRIORITY

This application reference to, incorporates the same herein, and claims all benefits accruing under 35 U.S.C. §119 from an application earlier filed in the Korean Intellectual Property Office on Dec. 19, 2008 and there duly assigned Serial No. 10-2008-0130380.

### BACKGROUND OF THE INVENTION

1. Field of the Invention

A method of preparing nano phosphor, and a display device including the nano phosphor.

2. Description of the Related Art

A phosphor is a material exhibiting luminescence characteristics upon energy excitation. In general, phosphor is used in various devices for a light source, such as a mercury fluorescent lamp, a mercury-free fluorescent lamp, an electron emission device, a plasma display panel (PDP), etc. Also, along with the development of new multimedia devices, phosphors are expected to be used in a wide variety of applications in the future.

Nano phosphors include small particle size, separable property among particles, excellent luminescence efficiency, a lowered light scattering effect, and so on. Phosphors made of small and well-separable particles usually exhibit a considerable reduction in luminescence efficiency. To compensate for a reduction in light emission efficiency, one attempt among conventional attempts has been to raise a heating temperature or increase a heating time.

In order to overcome such problems, heat spraying, hydrothermal methods, sol-gel synthesis methods, and laser crystallization methods have been suggested as alternative methods for increasing light emission efficiency. Despite having high quality characteristics, however, uses of such methods are severely limited due to high operating and equipment costs, and difficulty in upscale manufacturing.

### SUMMARY OF THE INVENTION

One or more embodiments include a method of preparing a nano phosphor having high crystalline properties.

One or more embodiments include a nano phosphor prepared using the method and having high crystalline properties.

Additional aspects will be set forth in part in the description which follows and, in part, will be apparent from the description, or can be learned by practice of the invention.

To achieve the above and/or other aspects, one or more embodiments may include a method of preparing a nano phosphor, the method including forming a metal oxide nanoparticle via a low-temperature synthesis process, forming a mixture by mixing the metal oxide nanoparticle and an inorganic salt and annealing the mixture.

The metal oxide nanoparticle may include a material selected from a group consisting of a lanthanides-based borate compound, a lanthanium-based borate compound and an yttrium-based borate compound. The metal oxide nanoparticle may include (Y_{1-a-b},Gdₐ)BO₃:M_{b} (where M is Eu, La, Tb, Pr, Nb, Sm, Gd, Eb or Yb, ‘a’ satisfies 0≦a≦0.40, and ‘b’ satisfies 0.01≦b≦0.30). The low-temperature synthesis process may be performed at a temperature equal to or lower than 500° C. The low-temperature synthesis process may be selected from a group consisting of a precipitation process, a hydrothermal process, or a solvothermal process. The inorganic salt may include at least one material selected from a group consisting of NaBO₂, LiBO₂, KBO₂, MgSO₄, Li₂SO₄, Na₂SO₄, K₂SO₄, MgCl₂, CaCl₂, SrCl₂, BaCl₂, Li₂CO₃, Na₂CO₃, K₂CO₃, Rb₂CO₃, LiCl, NaCl, KCl, RbCl and CsCl. The inorganic salt may include a nonmetallic component included within the metal oxide nanoparticle. The annealing may be performed using microwaves. The nano phosphor may include a (Y,Gd)BO₃:Eu phosphor. The process may further include post-annealing the mixture at a temperature in the range of 800° C. to 1500° C. after the annealing. The annealing may occur at a pressure of 40 atmospheres. The mixture may include a solvent, the inorganic salt being dissolved in the solvent.

According to another aspect of the present invention, there is provided a nano phosphor prepared according to the above process. The nano phosphor may be a (Y,Gd)BO₃:Eu phosphor.

According to another aspect of the present invention, there is provided a display device that includes the nano phosphor as described above.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicated the same or similar components, wherein:

FIG. 1 illustrates mechanism of removing defects in yttrium borate-based nano phosphors according to an embodiment of the present invention;

FIG. 2 is a graph of a result of X-Ray Diffraction (XRD) of (Y,Gd)BO₃:Eu nano phosphors prepared according to an embodiment of the present invention;

FIG. 3 is a scanning electron microscopy (SEM) image of the (Y,Gd)BO₃:Eu nano phosphors prepared according to an embodiment of the present invention;

FIG. 4A is an emission photoluminescence (PL) graph of the (Y,Gd)BO₃:Eu nano phosphors prepared according to an embodiment of the present invention and measured at an excitation wavelength of 254 nm;

FIG. 4B is a PL graph of the (Y,Gd)BO₃:Eu nano phosphors prepared according to an embodiment of the present invention and measured at an excitation wavelength of 147 nm of vacuum ultraviolet rays;

FIG. 5A is a PL graph of the (Y,Gd)BO₃:Eu nano phosphors prepared according to an embodiment of the present invention and measured at an excitation wavelength of 254 nm;

FIG. 5B is a PL graph of (Y,Gd)BO₃:Eu nano phosphors prepared according to a conventional technique and measured at an excitation wavelength of 254 nm;

FIG. 6A is a transmission electron Microscopy (TEM) image of the (Y,Gd)BO₃:Eu nano phosphors prepared according to an embodiment of the present invention;

FIG. 6B is a fast Fourier transform (FFT) diffractogram image of the (Y,Gd)BO₃:Eu nano phosphors prepared according to an embodiment of the present invention;

FIG. 7A is a TEM image of the (Y,Gd)BO₃:Eu nano phosphors prepared according to a conventional technique; and

FIG. 7B is a FFT image of the (Y,Gd)BO₃:Eu nano phosphors prepared according to a conventional technique.

### DETAILED DESCRIPTION OF THE INVENTION

The present invention will be described more fully hereinafter with reference to the accompanying drawings, in which exemplary embodiments of the invention are shown. As those skilled in the art would realize, the described embodiments may be modified in various different ways, all without departing from the spirit or scope of the principles for the present invention.

Metal oxide nanoparticles of nano phosphors are synthesized using a low-temperature synthesis method in which the sizes and shapes of synthesized particles may be easily controlled. Examples of low-temperature synthesis techniques include a precipitation technique, a hydrothermal technique, a solvothermal technique, and a wet synthesis technique using microwaves. The precipitation technique, the hydrothermal technique, the solvothermal technique, and the wet synthesis technique using microwaves may use a generally known process that is not particularly limited.

For example, in the precipitation technique, metal oxide nanoparticles may be synthesized by dissolving a precursor and then dropwise adding a basic solvent such as an ammonia solution, a Na₂CO₃ solution or NaOH into the resultant. In addition, in the hydrothermal technique or the solvothermal technique, metal oxide nanoparticles may be synthesized by dissolving a precursor together with urea and then increasing the temperature.

The low-temperature synthesis technique may be performed at a temperature equal to or lower than about 500° C., preferably, in the range of about 25° C. to about 200° C., and may use a general heating means such as a heater or microwaves. For example, metal oxide nano-scale precursor particles may be synthesized within 10 minutes to 20 minutes using microwaves.

Examples of the metal oxide nanoparticles may include a lanthanides-based borate compound, a lanthanium-based borate compound, and an yttrium-based borate compound. The yttrium-based borate compound may be, for example, (Y_{1-a-b},Gdₐ)BO₃:M_{b} (where M is Eu, La, Tb, Pr, Nb, Sm, Gd, Eb, or Yb, ‘a’ satisfies 0≦a≦0.40, and ‘b’ satisfies 0.01≦b≦0.30).

The metal oxide nanoparticles may have an average particle size in the range of about 1 nm to about 1,000 nm, preferably, in the range of about 50 nm to about 400 nm. However, the metal oxide nanoparticles prepared using a low-temperature synthesis technique is likely to have defects on a surface or crystal thereof. In addition, such surface or crystalline defects may reduce the crystalline properties and luminescent efficiency of the nano phosphors.

According to an embodiment of the present invention, nano phosphors are prepared by mixing the metal oxide nanoparticles prepared using a low synthesis technique with an inorganic salt and then annealing the mixture. The inorganic salt may compensate for the defects in the metal oxide nanoparticles. For example, the inorganic salt may be one or more of NaBO₂, LiBO₂, KBO₂, MgSO₄, Li₂SO₄, Na₂SO₄, K₂SO₄, MgCl₂, CaCl₂, SrCl₂, BaCl₂, Li₂CO₃, Na₂CO₃, K₂CO₃, Rb₂CO₃, LiCl, NaCl, KCl, RbCl and CsCl.

The surface or crystalline defects of the metal oxide nanoparticles are likely to occur at a nonmetallic ion site. Thus, the inorganic salt may include a nonmetallic component included in the metal oxide nanoparticles. For example, when the metal oxide nanoparticles are borate-based oxides, NaBO₂, LiBO₂, or KBO₂, that include boron as the nonmetallic component, may be used as the inorganic salt.

The inorganic salt may be used in the form of a solution. A solvent used to form the solution is not limited to any particular solvent as long as the solvent may dissolve the inorganic salt. Examples of the solvent may include water, methanol, ethanol, glycerol, ethylene glycol, and diethylene glycol.

The concentration of the inorganic salt in the solution is not particularly limited. For example, the concentration may be in the range of about 0.01 mol/liter to about 1 mol/liter. When the concentration exceeds this range, the inorganic salt may not sufficiently compensate for the defects, or a side reaction may occur due to inorganic salt that is not dissolved.

If necessary, the solution may further include a dispersant in order to increase the dispersibility of the metal oxide nanoparticles, etc. The dispersant may be one or more of citric acid, acetic acid, sodium acetate, ammonium acetate, oleic acid, sodium oleate, ammonium oleate, ammonium succinate, polyacrylate, glycine, and acylglutamate. The dispersant may additionally prevent agglomeration of the metal oxide nanoparticles.

Alternatively, the metal oxide nanoparticles may be prepared using a low-temperature synthesis technique, may be separated and washed, and then may be mixed with the inorganic salt. Such a mixing operation may be performed in the solvent as described above.

Then, annealing is performed on the mixture. At this time, general heating means, such as a convection oven, a heater or microwaves, may be used as a heat source. The annealing may be performed at a temperature in the range of about 100° C. to about 300° C. The time required for the annealing may vary according to the type of the heat source.

When microwaves are used as a heat source, the crystalline properties of the nano phosphors may be effectively increased within a short period of time while preventing growth of the particle size of the nano phosphors and preventing aggregation of the nano phosphors. The mixture is rapidly heated due to a direct reaction between radiated microwaves and the solvent/reactant so that the reaction time is reduced due to the kinetics of the microwaves. As a result a local super heating effect may be obtained, thereby effectively compensating for the surface and crystalline defects of the metal oxide nanoparticles. The microwaves may be electromagnetic waves with a frequency in the range of about 300 MHz to about 300 GHz.

The annealing may be effectively performed in pressurized conditions by using an internal pressure device such as an autoclave. When annealing, the pressure may be in the range of about 14.7 psi (1 atm) to about 600 psi (40.8 atm).

After the annealing is performed, the inorganic salt is removed by separating, washing and drying the resultant, thereby completing the preparation of the nano phosphors.

The luminescent efficiency of the nano phosphors may be increased by performing additional post-annealing. The post-annealing may be at a temperature in the range of about 800° C. to about 1500° C. The time required for the post-annealing may be in the range of about 10 minutes to about 5 hours.

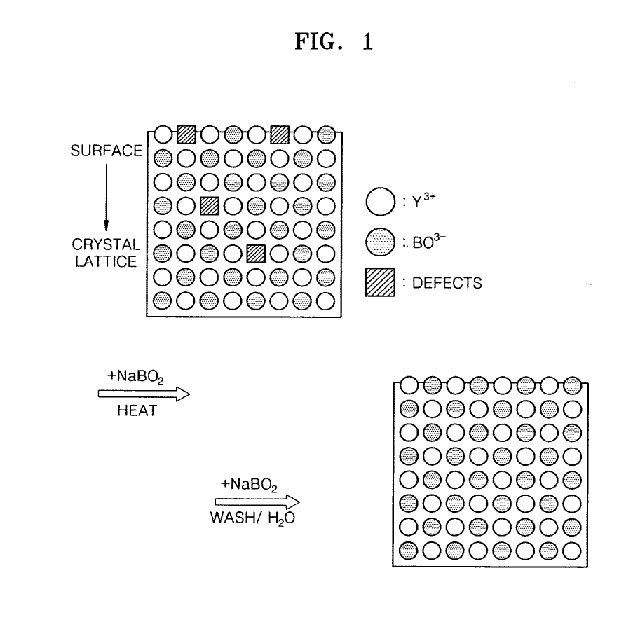

FIG. 1 illustrates the mechanism of removing defects of yttrium borate-based nano phosphors, according to an embodiment of the present invention. Yttrium borate nanoparticles, prepared using a low-temperature synthesis technique, may have surface and crystalline defects. The yttrium borate nanoparticles are mixed with an inorganic salt, and annealing is performed on the mixture, thereby compensating for the defects. Thus, nano phosphors having high crystalline properties may be obtained.

The nano phosphors may be used in a flat panel display such as a plasma display panel (PDP). The performance of the flat panel display is affected by the shape and crystalline properties of particles of the nano phosphors. In addition, since vacuum ultraviolet rays are absorbed into an ultrathin portion (having a thickness in the range of about 100 nm to 200 nm) of the particles of the nano phosphors, the surface properties of the nano phosphors importantly affects the luminescent efficiency of a display device such as a PDP that uses vacuum ultraviolet rays as an excitation source. On the other hand, phosphors prepared using a solid state reaction technique such as milling or pulverization operation have irregular shapes and many defects, and as a result, fail to obtain high luminescent efficiency and high resolution in a PDP.

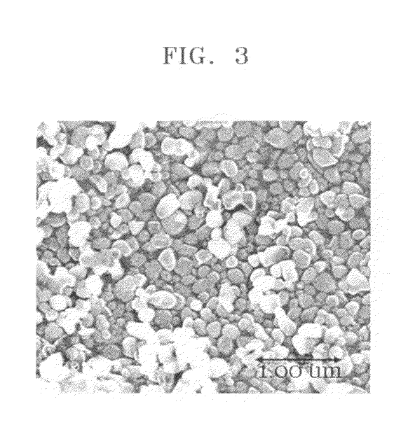

According to an embodiment of the present invention, since nano phosphors having high crystalline properties may be prepared, when the nano phosphors are used in a PDP, high luminescent efficiency and high resolution of the PDP may be achieved. In addition, since the nano phosphors are approximately spherical in shape and have regular particle sizes as illustrated in FIG. 3, high packing density may be obtained in a display device. In addition, the scattering of generated visible rays may be reduced, thereby increasing screen brightness and obtaining high resolution for the display device.

The present invention will now be described in more detail with reference to the following examples. However, these examples are for illustrative purposes only and are not intended to limit the scope of the present invention.

### Example 1

### Preparation According to an Embodiment of the Present Invention

2.681 g of Y(NO₃)₃.6H₂O, 0.428 g of Eu(NO₃)₃.5H₂O, 1.210 g of H₃BO₃, 0.903 g of Gd(NO₃)₃.6H₂O, and 2.523 g of NH₂CONH₂, which are precursors, were prepared and dissolved in diethylene glycol. (Y,Gd)BO₃:Eu nanoparticles having an average particle size of about 200 nm were synthesized by radiating microwaves having a frequency of 2.45 MHz into 500 ml of the resultant solution for 10 minutes at a power of 800 W. Then, the (Y,Gd)BO₃:Eu nanoparticles were separated by a centrifugal separator, washed by distilled water, and then dried.

A solution in which 0.05 mol/liter of NaBO₂ dissolved in distilled water was prepared, and then the (Y,Gd)BO₃:Eu nanoparticles were dispersed in the solution. Microwaves having a frequency of 2.45 GHz were radiated into the solution for 20 minutes in pressurized conditions of 40 atm at a power of 800 W. After the pressurized microwave annealing was performed, NaBO₂ that did not react was removed by separating, washing and drying the resultant, and then annealing was performed for 1 hour at 900° C. under an oxidation condition, thereby completing the preparation of (Y_{0.7},Gd_{0.2})BO₃:(Eu³⁺)_{0.1} nano phosphors having a size of about 200 nm.

### Comparative Example 1

### Prepared According to Another Process

2.681 g of Y(NO₃)₃.6H₂O, 0.428 g of Eu(NO₃)₃.5H₂O, 1.210 g of H₃BO₃, 0.903 g of Gd(NO₃)₃.6H₂O, and 2.523 g of NH₂CONH₂, which are precursors, were prepared, and dissolved in diethylene glycol. (Y,Gd)BO₃:Eu nanoparticles having an average particle size of about 200 nm were synthesized by radiating microwaves having a frequency of 2.45 MHz into 500 ml of the resultant solution for 10 minutes at a power of 800 W. Then, the (Y,Gd)BO₃:Eu nanoparticles were separated by a centrifugal separator, washed by water, and then dried.

Obtained Y(Gd)—B—O:Eu nanoparticles were annealed for 1 hour at 900° C. under an oxidation condition, thereby completing the preparation of (Y_{0.7},Gd_{0.2})BO₃:(Eu³⁺)_{0.1}.

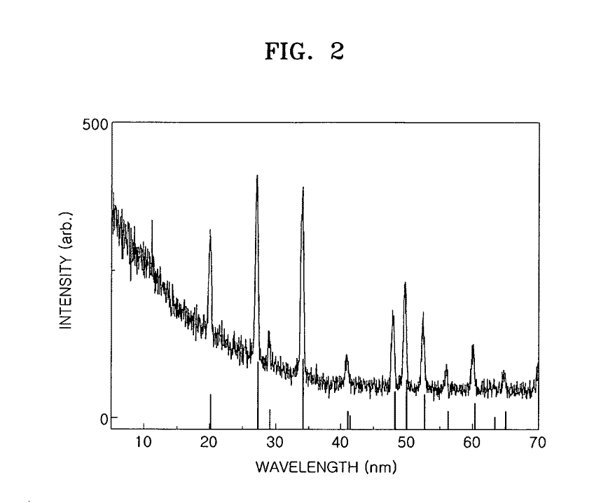

Turning now to FIGS. 2 and 3, FIG. 2 is a graph of a result of X-Ray Diffraction (XRD) of the (Y,Gd)BO₃:Eu nano phosphors prepared according to Example 1 and FIG. 3 is a scanning electron microscopy (SEM) image of the (Y,Gd)BO₃:Eu nano phosphors prepared according to Example 1. Referring to FIGS. 2 and 3, it may be seen that nanoparticles having a regular size of about 200 nm were synthesized.

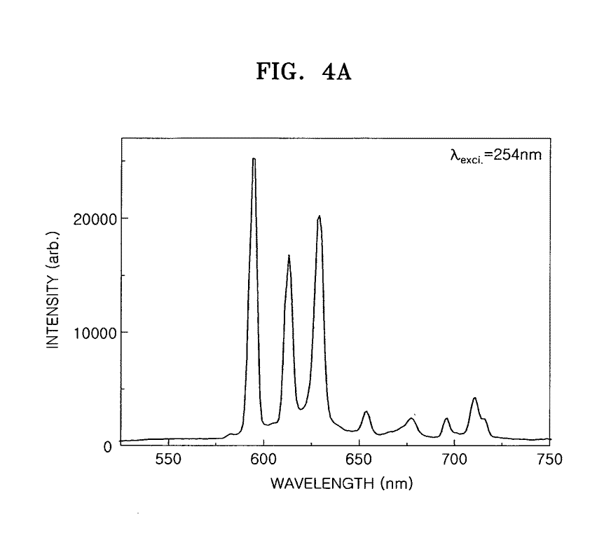

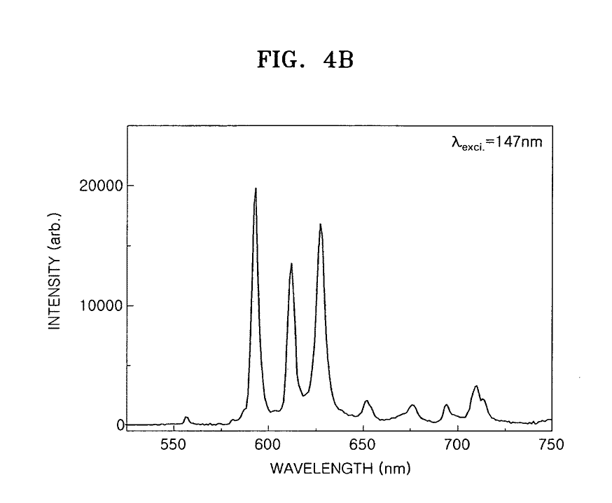

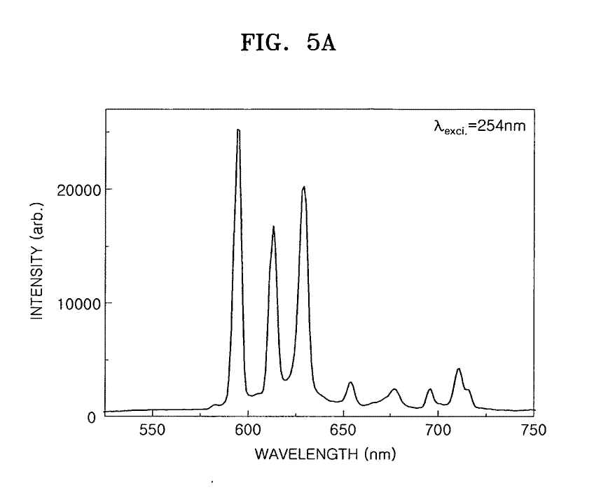

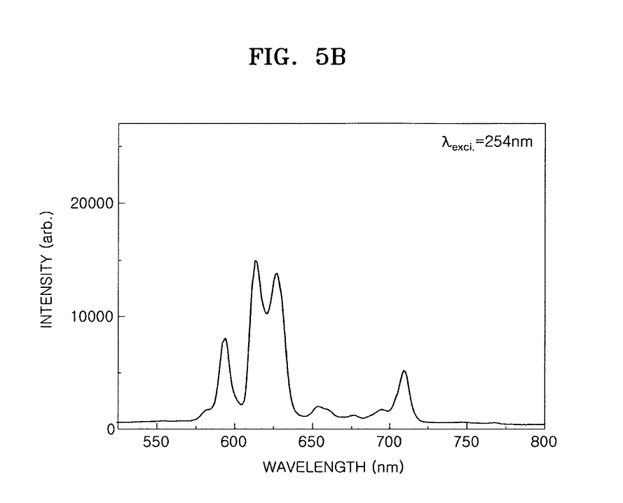

FIG. 4A is an emission photoluminescence (PL) graph of the (Y,Gd)BO₃:Eu nano phosphors prepared according to Example 1 and measured at an excitation wavelength of 254 nm. FIG. 4B is a PL graph of the (Y,Gd)BO₃:Eu nano phosphors prepared according to Example 1 and measured at an excitation wavelength of 147 nm of vacuum ultraviolet rays. In FIG. 4B, the (Y,Gd)BO₃:Eu nano phosphors were measured in the arrangement of a thin film. FIG. 5A is a PL graph of the (Y,Gd)BO₃:Eu nano phosphors prepared according to Example 1 and measured at an excitation wavelength of 254 nm. FIG. 5B is a PL graph of the (Y,Gd)BO₃:Eu nano phosphors prepared according to the Comparative Example 1 and measured at an excitation wavelength of 254 nm. Referring to FIGS. 4A through 5B, it may be seen that the (Y,Gd)BO₃:Eu nano phosphors prepared according to Example 1 has an increased PL.

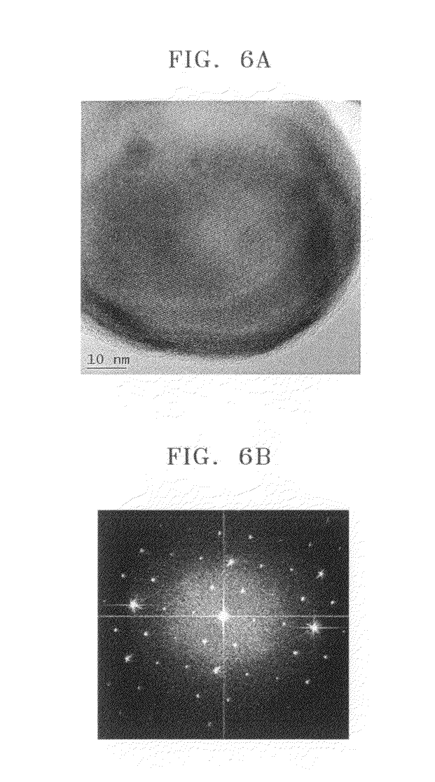

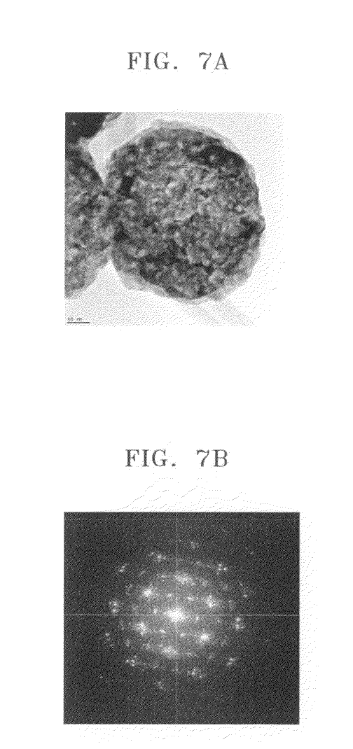

FIGS. 6A and 6B are a transmission electron Microscopy (TEM) image and a fast Fourier transform (FFT) diffractogram image respectively of the (Y,Gd)BO₃:Eu nano phosphors prepared according to the process of Example 1. FIGS. 7A and 7B are a TEM image and a FFT image respectively of the (Y,Gd)BO₃:Eu nano phosphors prepared according to the process of the Comparative Example 1.

It may be seen from FIGS. 6A, 6B, 7A and 7B that the (Y,Gd)BO₃:Eu nano phosphors prepared according to the process of the Comparative Example 1 have defects of irregular particles, however the (Y,Gd)BO₃:Eu nano phosphors prepared according to the process of Example 1 have almost no defects and have high crystalline properties. That is, referring to FIG. 6A, a regular lattice shape is shown, which means that an entire particle is of a single phase, that is, a single crystal. When a particle is composed of a single crystal instead of agglomerated crystals, the particle has excellent crystalline properties. FIG. 6B is a diffractogram of FIG. 6A. Referring to FIG. 6B, it may be seen that white spots are regularly arranged. Thus, it may be concluded that a single crystal particle of FIG. 6B was synthesized according to the process of Example 1. However, referring to FIGS. 7A and 7B, a single crystal particle was not synthesized when prepared according to the process of the Comparative Example 1. In addition, since white spots are not regularly arranged in the diffractogram of FIG. 7B, it may be concluded that particles with defects were synthesized instead of a single crystal.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method of preparing a nano phosphor, the method comprising:
forming a metal oxide nanoparticle via a low-temperature synthesis process;
forming a mixture by mixing the metal oxide nanoparticle and an inorganic salt; and
annealing the mixture.

2. The method of claim 1, wherein the metal oxide nanoparticle comprises a material selected from a group consisting of a lanthanides-based borate compound, a lanthanium-based borate compound and an yttrium-based borate compound.

3. The method of claim 1, wherein the metal oxide nanoparticle comprises (Y_{1-a-b},Gdₐ)BO₃:M_{b} (where M is Eu, La, Tb, Pr, Nb, Sm, Gd, Eb or Yb, ‘a’ satisfies 0≦a≦0.40, and ‘b’ satisfies 0.01≦b≦0.30).

4. The method of claim 1, wherein the low-temperature synthesis process is performed at a temperature equal to or lower than 500° C.

5. The method of claim 1, wherein the low-temperature synthesis process is selected from a group consisting of a precipitation process, a hydrothermal process, or a solvothermal process.

6. The method of claim 1, wherein the inorganic salt comprises at least one material selected from a group consisting of NaBO₂, LiBO₂, KBO₂, MgSO₄, Li₂SO₄, Na₂SO₄, K₂SO₄, MgCl₂, CaCl₂, SrCl₂, BaCl₂, Li₂CO₃, Na₂CO₃, K₂CO₃, Rb₂CO₃, LiCl, NaCl, KCl, RbCl and CsCl.

7. The method of claim 1, wherein the inorganic salt comprises NaBO₂.

8. The method of claim 1, wherein the inorganic salt comprises a nonmetallic component included within the metal oxide nanoparticle.

9. The method of claim 1, wherein the annealing is performed using microwaves.

10. The method of claim 1, wherein the nano phosphor comprises a (Y,Gd)BO₃:Eu phosphor.

11. The method of claim 1, further comprising post-annealing the mixture at a temperature in the range of 800° C. to 1500° C. after the annealing.

12. The method of claim 1, wherein the annealing occurs at a pressure of 40 atmospheres.

13. The method of claim 1, wherein the mixture includes a solvent, the inorganic salt being dissolved in the solvent.

14. A nano phosphor prepared according to the method of claim 1.

15. The nano phosphor of claim 14, wherein the nano phosphor comprises a (Y,Gd)BO₃:Eu phosphor.

16. A display device comprising the nano phosphor of claim 14.
